(19) United States
(12) Patent Application Publication
(10) Pub. No.: US 2011/0010512 A1
(43) Pub. Date: Jan. 13, 2011

(54) METHOD FOR CONTROLLING STORAGE SYSTEM HAVING MULTIPLE NON-VOLATILE MEMORY UNITS AND STORAGE SYSTEM USING THE SAME

(75) Inventors: Tzu-chieh Lin, Hsinchu City (TW); Hong-ching Chen, Fang-Shan City (TW); Yeow-chyi Chen, Sijhih City (TW)

Correspondence Address: KIRTON AND MCCONKIE, 60 EAST SOUTH TEMPLE,, SUITE 1800, SALT LAKE CITY, UT, 84111, US

(73) Assignee: MEDIATEK INC., Hsin-Chu (TW)

(21) Appl. No.: 12/500,457

(22) Filed: Jul. 9, 2009

(51) Int. Cl. G06F 12/00

(52) U.S. Cl. 711/158; 711/E12.001

(57) ABSTRACT

A method for controlling a storage system and the storage system using this method are disclosed. In the storage system, at least two memory units share an I/O bus. The shared I/O bus transfers information for each memory unit to execute an operation. The operation has at least one high priority cycle and at least one low priority cycle. When a low priority cycle is overlapped with a high priority cycle, the low priority cycle is suspended, and the high priority cycle is operated first. After the high priority cycle is finished, the suspended low priority cycle is then resumed. By doing so, the shared I/O bus may be used by one memory unit during a busy cycle for another memory unit, during which the latter memory unit does not use the I/O bus. Therefore, the I/O bus can be more efficiently used.

### TECHNICAL FIELD OF THE INVENTION

The present invention relates to a non-volatile memory storage system, more particularly, to control of a storage system including multiple non-volatile memory units such as flash chips, in which at least two memory units share an I/O (Input/Output) bus.

### BACKGROUND OF THE INVENTION

Storage systems including multiple non-volatile memory units such as flash chips are widely used in various fields. Ideally, it is preferred that each memory unit has its own dedicate I/O (Input/Output) bus to transfer various commands, information and data. However, in practice, taking a flash storage system as an example, flash chips are grouped into a plurality of channels (e.g. m channels), and each channel comprises n flash chips sharing an identical I/O bus. That is, the storage system has m x n flash chips. The n flash chips of one channel are respectively and individually controlled by their own chip enable (CE) signals CE(1), CE(2), . . . , CE(n).

For read and write operations, there are three types of cycles: a page level command cycle, a busy cycle and a data transfer cycle. For erase operation, there are two types of cycles: a block level command cycle and a busy cycle. In the page level or block level command cycle, operation command(s) and address information are transferred via the I/O bus. In the busy cycle, data is read from the flash chip, written into the flash chip or cleaned from the flash chip, thus the I/O bus is idle. In the data transfer cycle, the data is put on the I/O bus so that a controller may capture the data from the I/O bus to use, for example.

FIG. 1 is a diagram showing an example of read operation of a flash storage system using a prior art control method. In this example, two flash chips sharing an I/O bus are described. A controller of the storage system instructs the I/O bus to transfer a read page level command for a first flash chip by controlling a chip enable (CE) signal CE(1) for the first flash chip according to a request of a host. A command cycle during which the read page command is transferred is indicated by reference number 101. After the command cycle 101 is finished, there will be a read busy cycle 103 for the first flash chip. During the read busy cycle 103, data is read from the first flash chip and put into a page buffer of the flash. After the read busy cycle 103, the data is transferred out of the storage system via the I/O bus during a data transfer cycle 105 for the first flash chip. In accordance with the prior art method, the controller must wait until the data transfer cycle 105 for the first flash chip is finished, thus the controller can deal with the request for the second flash chip during another command cycle 201. After the read page level command cycle 201 is finished, there will also be a read busy cycle 203 and another data transfer cycle 205 for the second flash chip. As can be seen, the I/O bus is idle during the read busy cycles 103 and 203. The present invention provides a more efficient control method for such a storage system with an I/O bus sharing architecture.

### SUMMARY OF THE INVENTION

The present invention is to provide a method for controlling a storage system which has multiple non-volatile memory units such as flash chips. In the storage system, at least two memory units share an I/O bus. By using the method of the present invention, the I/O bus can be more efficiently used. The present invention is to further provide a storage system using such a control method.

In a storage system including a plurality of non-volatile memory units sharing an I/O (Input/Output) bus, the shared I/O bus transfers information for each memory unit to execute an operation, the operation has at least one high priority cycle and at least one low priority cycle. A method for controlling a storage system in accordance with the present invention comprises steps of: suspending a low priority cycle when the low priority cycle is overlapped with a high priority cycle, and operating the high priority cycle first; and resuming the suspended low priority cycle after the high priority cycle is completed.

A storage system in accordance with the present invention implementing the above method comprises: a plurality of non-volatile memory units; an I/O (Input/Output) bus shared by the memory units, for transferring information for each memory unit to execute an operation, the operation having at least one high priority cycle and at least one low priority cycle; and a controller for suspending a low priority cycle when the low priority cycle is overlapped with a high priority cycle, and operating the high priority cycle first; and resuming the suspended low priority cycle after the high priority cycle is completed.

The high priority cycle can be a command cycle for transferring a page level or block level command and address information. The low priority cycle can be a data transfer cycle for transferring data, which is read from the memory unit or is to be written to the memory unit.

### BRIEF DESCRIPTION OF THE DRAWINGS

The present invention will be described in detail in conjunction with the appending drawings, in which:

FIG. 1 is a diagram showing an example of read operation of a flash storage system using a prior art control method;

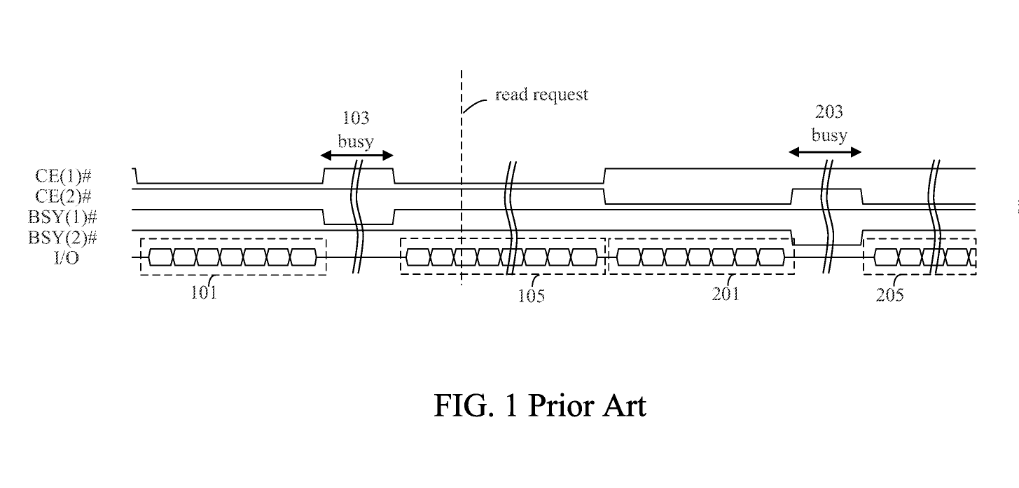

FIG. 2 is a block diagram of a storage system having multiple flash chips;

FIG. 3 is a timing chart showing a read operation for a flash chip;

FIG. 4 is a timing chart showing a write operation for a flash chip;

FIG. 5 is a timing chart showing an erase operation for a flash chip; and

FIG. 6 is a diagram showing an example of read operation of the flash storage system using a method in accordance with the present invention.

### DETAILED DESCRIPTION OF THE INVENTION

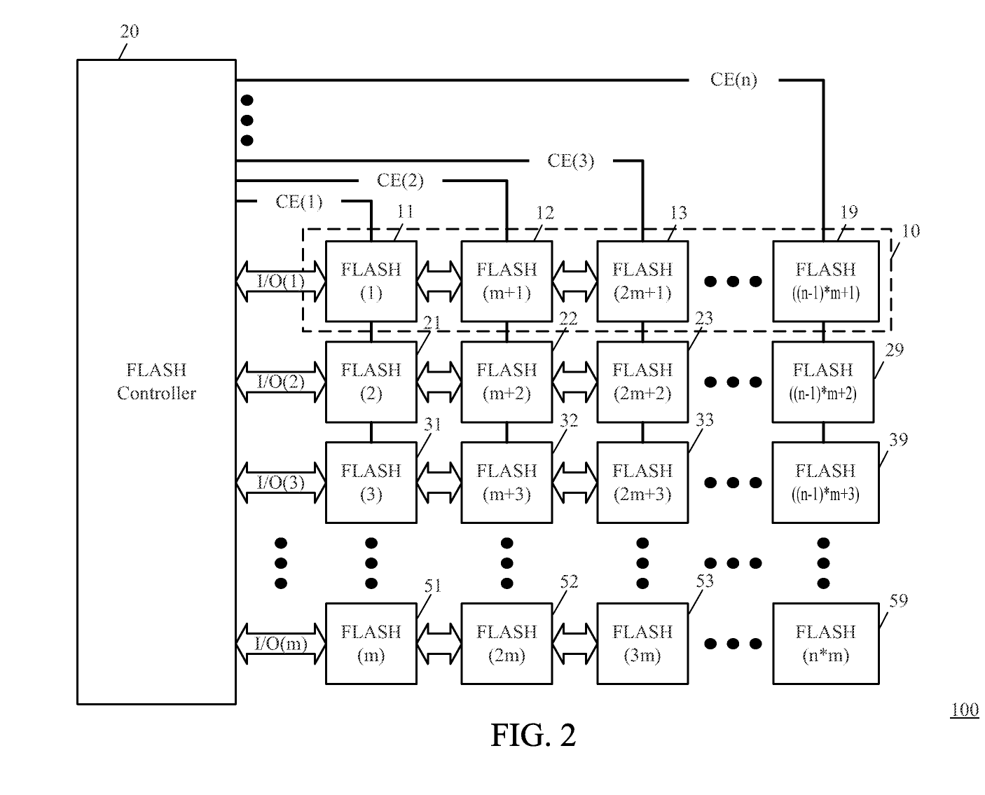

FIG. 2 is a block diagram of a storage system 100. The storage system 100 has m×n flash chips 11-19, 21-29, 51-59. As can be seen, the flash chips are divided into m channels; each channel includes n flash chips. The n flash chips of one channel share an identical I/O bus. For example, the flash chips 11, 12, . . . , 19 of the first channel 10 share an I/O bus I/O(1). A flash controller 20 controls the respective flash chips by using the m I/O buses (i.e. I/O(1) to I/O(m)) and chip enable signals CE(1) to CE(n). For example, CE(1) is used to control every first flash chip 11, 21, 31, . . . , 51 of the respective channels. The rest can be deduced accordingly. By doing so, the flash controller 20 is able to exactly control any one of the flash chips.

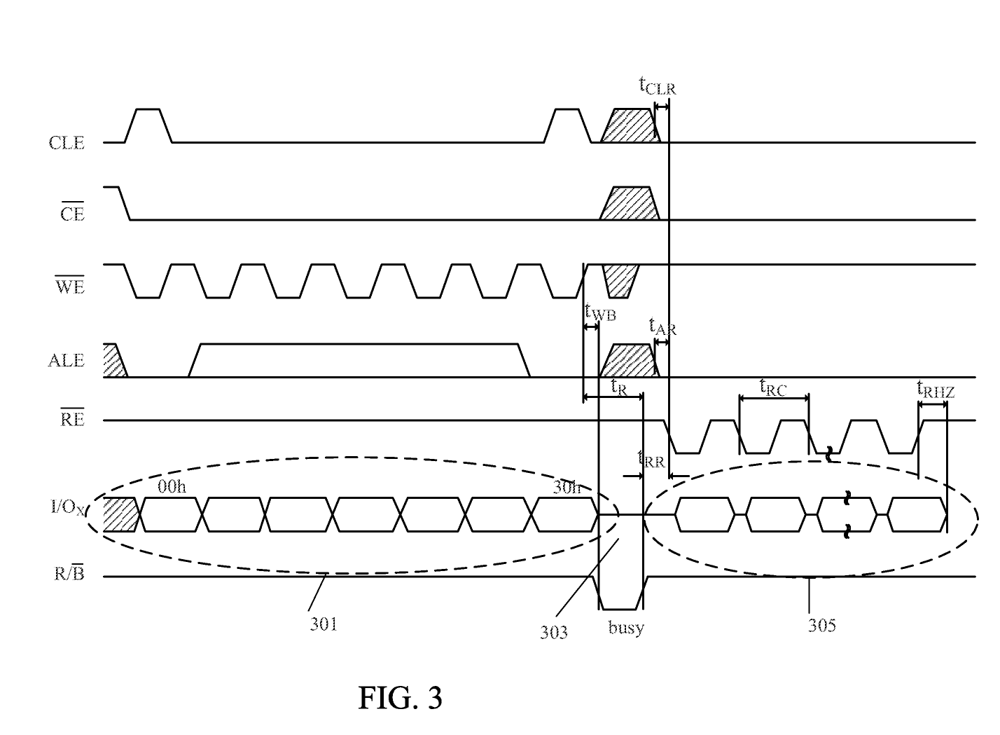

FIG. 3 is a timing chart showing a read operation for one flash chip x, where CLE indicates “command latch enable”, C̅E̅ indicates “chip enable”, W̅E̅ indicates “write enable”, ALE indicates “address latch enable”, R̅E̅ indicates “read enable”, I/Ox indicate the I/O bus for the specific flash chip x, R/ B̅ indicates “ready/busy”. The signals mentioned above are commonly used in this field. The controller 20 transfers operation command(s) and address information on the I/O bus during a page level command cycle 301 to read data stored in the flash chip x. In the page level command cycle 301, an operation command “00h” (i.e. read command) is transferred. In addition, column address and row address information follows the read command. The operation command “30h” following the address information means “data capture”. According to the operation command “30h”, the operation is switched to a busy cycle 303. The ready/busy signal R/ B̅ drops from high to low. During the busy cycle 303, the I/O bus is idle and the data stored in the flash chip x is read and moved to a page buffer (not shown) of the flash chip x. After the busy cycle 303, the operation enters a data transfer cycle 305. During the data transfer cycle 305, data is put on the I/O bus to be transferred out. The data transfer is controlled by using the read enable signal R̅E̅.

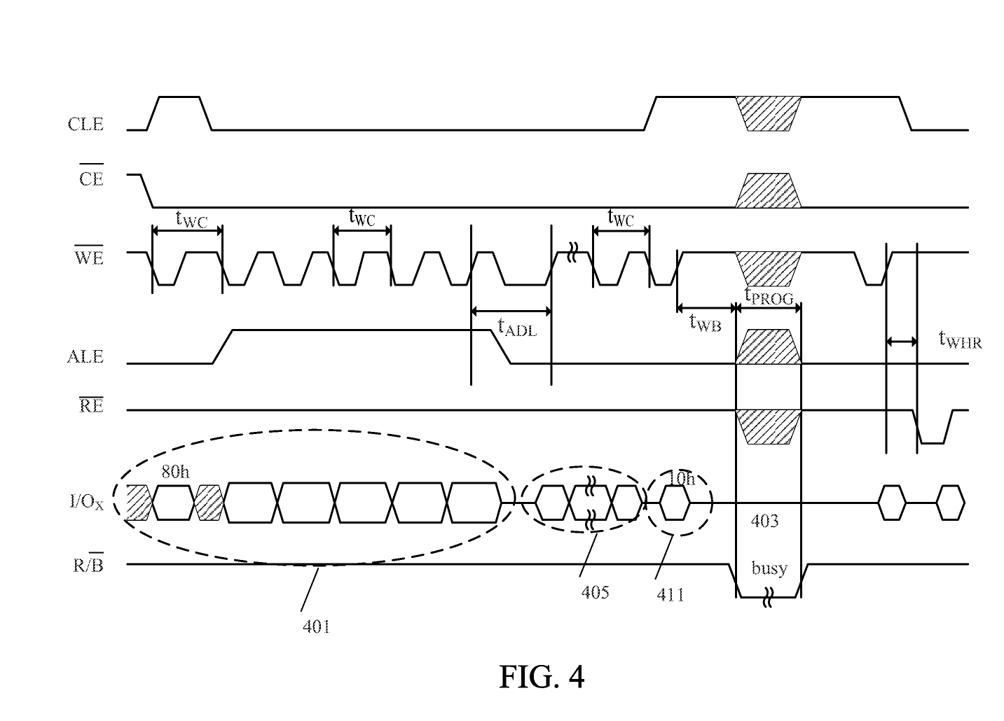

FIG. 4 is a timing chart showing a write operation for the flash chip x. The controller 20 transfers operation command(s) and address information on the I/O bus during a page level command cycle 401 for writing data to the flash chip x. The operation command “80h” is a serial data input command. Column address and row address information is then provided. After the write page level command including the operation command and the address information is transferred, data to be written to the flash chip x is transferred to the page buffer via the I/O bus during a data transfer cycle 405. After the data is completely transferred, a program command “10h” is transferred during another page level command cycle 411. Then, the operation enters a busy cycle 403. During the busy cycle 403, the data is moved from the page buffer to the flash unit x and the I/O bus is idle.

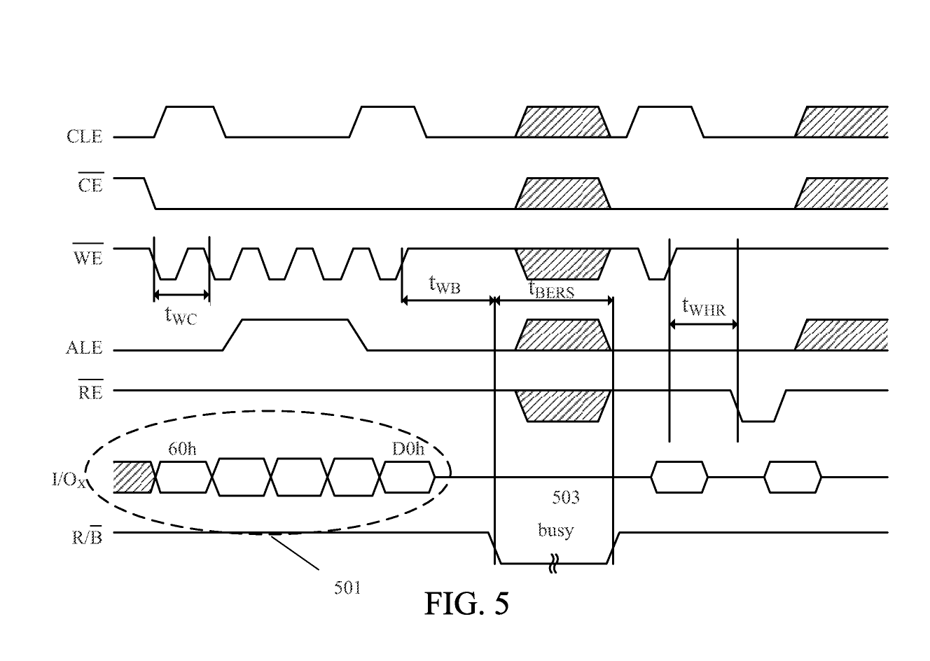

FIG. 5 is a timing chart showing an erase operation for the flash chip x. The controller 20 transfers command(s) and address information during a block level command cycle 501 on the I/O bus. The operation command “60h” is an auto block erase setup command. Row address information is then provided. The operation command “D0h” is an erase command. According to the erase command D0h, the operation enters to a busy cycle 503 to erase the data in the flash chip x.

As can be seen, in each of read, write and erase operations, there are at least one page or block level command cycle and a busy cycle. In read or write operation, there is still a data transfer cycle. No matter it is read, write or erase operation, during the busy cycle, the I/O bus is idle. The present invention proposes a method for controlling the storage system so as to efficiently use the I/O bus during the busy cycle.

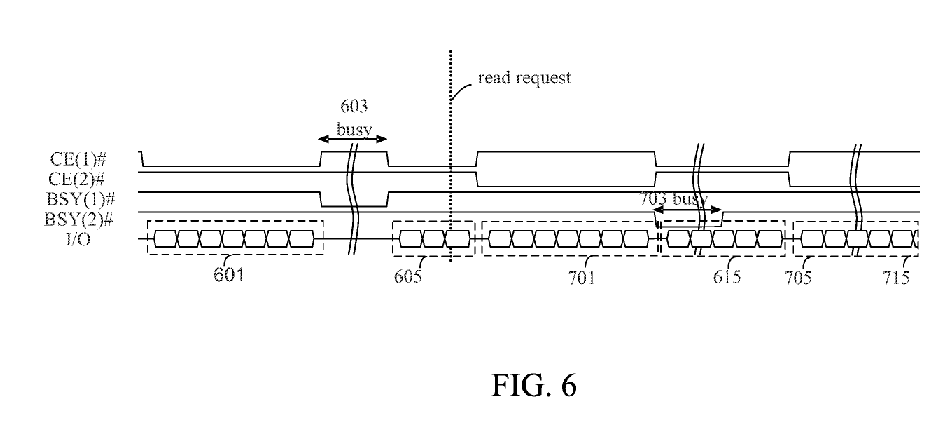

FIG. 6 is a diagram showing an example of read operation of the flash storage system using the method in accordance with the present invention. In this example, two flash chips (e.g. flash chips 11 and 12 of FIG. 2) sharing an I/O bus (e.g. I/O(1)) are described. The controller 20 of the storage system 100 instructs the I/O bus I/O(1) to transfer a read page level command for the first flash chip 11 by controlling a chip enable (CE) signal CE(1) for the first flash chip 11 according to a request of a host (not shown). The read page level command including operation command(s) and address information is transferred on the I/O bus I/O(1) during a page level command cycle 601 for the first flash chip 11. After the page level command cycle 601 is finished, there will be a read busy cycle 603 for the first flash chip 11 as described above. During the read busy cycle 603, data is read from the first flash chip 11 and put into the page buffer (not shown). After the read busy cycle 603, the data is transferred out via the I/O bus I/O(1) during a data transfer cycle 605 for the first flash chip 11. Supposed that the host (not shown) requests to read data stored in the second flash chip 12 during the data transfer cycle 605 for the first flash chip 11, in accordance with the present invention, the controller 20 will suspend the data transfer cycle 605 and instructs to transfer a read page level command for the second flash chip 12 on the I/O bus I/O(1).

The read page level command for the second flash chip 12 is transferred during a page level cycle 701. As described, there will be a read busy cycle 703 for the second flash chip 12 following the page level command cycle 701. Since the shared I/O bus is idle during the busy cycle 703, it is possible to use the I/O bus at this time. The controller 20 instructs to resume the data transfer for the first flash chip 11. The resumed data transfer cycle for the first flash chip 11 is indicated by a reference number 615. That is, the whole data transfer cycle for the first flash chip 11 is divided into two cycles 605 and 615. Similarly, the data transfer cycle for the second flash chip 12 can also be suspended and resumed so as to be divided into cycles 705 and 715.

Since the page or block level command is preferred to be transferred in the integrity, the page or block level command cycle (or simply referred to as “command cycle”) is given a high priority to be transferred via the I/O bus. The data can be divided into segments to be transferred, and therefore the data transfer cycle is given a low priority to be transferred via the I/O bus. When a high priority cycle and a low priority cycle are overlapped with each other, the low priority cycle is suspended and the high priority cycle is operated first. By doing so, the busy cycle, which usually follows the high priority cycle (i.e. the command cycle), can be used to execute operation of the resumed low priority cycle (i.e. data transfer cycle).

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A method for controlling a storage system, the storage system including a plurality of non-volatile memory units sharing at least one I/O (Input/Output) bus, the shared I/O bus transferring information for each memory unit to execute an operation, the operation having at least one of a high priority cycle and a low priority cycle; the method comprising steps of:
suspending a low priority cycle when the low priority cycle is overlapped with a high priority cycle, and operating the high priority cycle first; and
resuming the suspended low priority cycle after the high priority cycle is finished.

2. The method of claim 1, wherein the high priority cycle is a command cycle, during which at least one operation command is transferred on the I/O bus.

3. The method of claim 2, wherein address information for the memory unit is also transferred on the I/O bus during the command cycle.

4. The method of claim 1, wherein the low priority cycle is a data transfer cycle, during which data is transferred on the I/O bus.

5. The method of claim 1, wherein the operation comprises a read operation.

6. The method of claim 1, wherein the operation comprises a write operation.

7. The method of claim 1, wherein the operation comprises an erase operation.

8. A storage system comprising:
a plurality of non-volatile memory units;
an I/O (Input/Output) bus shared by the memory units, for transferring information for each memory unit to execute an operation, the operation having at least one of a high priority cycle and a low priority cycle; and
a controller for suspending a low priority cycle when the low priority cycle is overlapped with a high priority cycle, operating the high priority cycle first; and resuming the suspended low priority cycle after the high priority cycle is finished.

9. The storage system of claim 8, wherein the high priority cycle is a command cycle, during which an operation command is transferred on the I/O bus.

10. The storage system of claim 9, wherein address information for the memory unit is also transferred on the I/O bus during the command cycle.

11. The storage system of claim 8, wherein the low priority cycle is a data transfer cycle, during which data is transferred on the I/O bus.

12. The storage system of claim 8, wherein the operation comprises a read operation.

13. The storage system of claim 8, wherein the operation comprises a write operation.

14. The storage system of claim 8, wherein the operation comprises an erase operation.
